(19) United States
(12) Patent Application Publication
(10) Pub. No.: US 2025/0207721 A1
(43) Pub. Date: Jun. 26, 2025

(54) MOUNTING DEVICE FOR MOUNTING AN ACCESSORY ON A STRAPPING STRIP AND ASSEMBLY OF SUCH A DEVICE AND OF A STRAPPING STRIP

(71) Applicant: CAILLAU, ROMORANTIN-LANTHENAY (FR)

(72) Inventors: Martial BLANCHET, ROMORANTIN-LANTHENAY (FR); Leny IBANEZ, MARCILLY EN GAULT (FR)

(21) Appl. No.: 18/989,141

(22) Filed: Dec. 20, 2024

(30) Foreign Application Priority Data
Dec. 21, 2023 (FR) 2314918

(51) Int. Cl. F16M 13/02; B25B 5/14

(52) U.S. Cl. CPC F16M 13/022; B25B 5/147

(57) ABSTRACT

The mounting device for mounting an accessory on a strapping strip comprises a support strip comprising a fixing area for an accessory, a slide system for retaining the support strip relative to the strapping strip while allowing the support strip to slide along the strapping strip and a locking system for blocking this sliding in a given position of the support strip relative to the strapping strip.

### TECHNICAL FIELD

This disclosure relates to a mounting device for mounting an accessory on a strapping strip.

The strapping strip is particularly disposed around an object such as a tube or an enclosure portion. In particular, the enclosure may be a tank storing fluid, particularly a tank containing a gas such as hydrogen. The accessory may be a functional element that must cooperate with the object around which the strapping strip is disposed and/or the accessory may be or may comprise a sensor used to detect physicochemical parameters in the environment of the object or on the object. For example, this sensor may be a temperature or pressure sensor. It may also be a leak sensor, used to detect a local pressure variation or used to detect the presence of a chemical agent, particularly a gas, in the environment of the object.

### SUMMARY

The disclosure aims to allow using the strapping strip to carry the accessory by arranging it in the immediate vicinity of the object.

Thus, according to a first subject, this disclosure concerns a mounting device for mounting an accessory on a strapping strip, the device comprising a support strip comprising a fixing area for an accessory, a slide system for retaining the support strip relative to the strapping strip while allowing the support strip to slide along the strapping strip and a locking system for blocking this sliding in a given position of the support strip relative to the strapping strip; the support strip is disposed outside the strapping strip and a hollow space is arranged between the inner face of the fixing area and the outer face of the strapping strip.

Thanks to this disclosure, the support strip can be moved on the strapping strip until it reaches the given position, in which it may be held blocked. The given position may be a single, predetermined position on the strapping strip. The given position may also be a position in which it is desired to place the support strip relative to the strapping strip, depending on the positioning desired for the accessory. It can also be provided that the strapping strip has several target areas in which the blocking of the support strip is possible, and that the given position is defined by one of these target areas, chosen according to the context. This context may particularly relate to the ease of mounting the accessory, to its accessibility, or to its positioning in a determined region of the object on which the strapping strip is disposed, for example near a risk area from the point of view of leaks, a pressure variation or a temperature variation.

The strapping strip may be placed on the object while it carries the support strip or the support strip may be added onto the strapping strip while it is in place on the object. In both cases, once the strapping strip is positioned on the object, the support strip may be brought to the given position to allow the accessory to be correctly positioned.

The support strip is located outside the strapping strip. Thanks to the hollow space arranged between these two strips in the region of the fixing area, the mounting of the accessory is facilitated and this mounting may be carried out without bearing against the strapping strip and without interfering with the clamping of this strip on the object to be clamped. In addition, the support strip may be capable of sliding relative to the strapping strip, even when the accessory is mounted or pre-mounted on the strapping strip.

Optionally, the slide system comprises at least one pair of sliding lugs, which comprises two sliding lugs carried by a sliding area of the support strip, these sliding lugs being spaced from each other in a width direction and having ends folded under the support strip by arranging a space therebetween and the inner face of the support strip, the slide system optionally comprising two pairs of sliding lugs respectively disposed on either side of the fixing area.

Optionally, the fixing area is protruding radially outwards relative to the sliding area by being optionally formed in a portion of the support strip which is deformed radially outwards.

Optionally, the fixing area comprises at least one fixing orifice, particularly a screw orifice, in particular an orifice having a threaded skirt or an orifice in register with the threaded orifice of a nut.

Optionally, the support strip comprises a blocking portion which has a first locking member, the first locking member being particularly an aperture, a cup, a boss or a locking lug.

Optionally, the first locking member is permanently biased in a locking configuration.

Optionally, the blocking portion is configured to be elastically moved, particularly to be elastically deformed, in order to unlock the first locking member so as to unblock the sliding.

Optionally, the support strip comprises an unlocking tab, configured to be manipulated so as to unlock the locking system to unblock the sliding.

Optionally, the unlocking tab is raised radially relative to the blocking portion.

According to a second object, this disclosure concerns a fixing assembly comprising a strapping strip and a mounting device as defined according to the first object of this disclosure. The strapping strip is optionally a clamping strip of a clamping collar.

Optionally, the edges of the strapping strip are inserted into the space arranged between the folded ends of the sliding lugs and the inner face of the support strip.

Optionally, the strapping strip has a plurality of second locking members for cooperating with the first locking member, the second locking members being distributed over at least part of the length of the strapping strip, the first and second locking members being particularly mating male/female members.

Optionally, the strapping strip has a groove on each of its longitudinal edges.

Optionally, the strapping strip has, on its longitudinal edges, raised rims under which the grooves are formed.

Optionally, the strapping strip comprises an inner strip and an outer strip, the outer strip projecting laterally relative to the inner strip so as to form the groove on each of the longitudinal edges of the strapping strip. In this case, optionally, the outer strip is metallic, while the inner strip is made of polymer.

The strapping strip may have the sole function of carrying the accessory, via the support strip. However, it may also have another function, such as for example locally rigidifying or consolidating the object it is strapping, or allowing this object to be fixed to a support such as, for example, the chassis of a vehicle. It may be a clamping strip intended not only to strap the object, but also to exert clamping constraints thereon, for example for its mounting and holding in position on a support or for its connection with another object. The object which is strapped by the strapping strip may have, in its region around which the strapping strip is disposed, the shape of a cylinder of revolution, or another shape, for example a parallelepiped shape or generally a shape defining a closed contour, with or without flats.

### BRIEF DESCRIPTION OF THE DRAWINGS

The description will be well understood and its advantages will appear better upon reading the following detailed description, of embodiments represented as non-limiting examples. The description refers to the appended drawings in which:

FIG. 1 is a general side view of the assembly comprising a strapping strip and a mounting device according to this disclosure.

FIG. 2 is an enlarged perspective view, showing the mounting device, mounted on the strapping strip of which only a portion is represented.

FIG. 3 is a perspective view of the support strip of the mounting device according to one example, this strip being seen from the outside.

FIG. 4 is a perspective view of the support strip of FIG. 3, seen from the inside.

FIG. 5 shows the support strip according to one variant, in a side view, that is to say a view in which the direction perpendicular to the plane of the figure is the transverse direction.

FIG. 6 is a partial perspective cutaway view, showing the strapping strip and its cooperation with the support strip.

FIG. 7 is a cross-sectional view of the strapping strip, showing its cooperation with the support strip.

FIG. 8 is a view similar to FIG. 7, for one variant of embodiment.

FIG. 9 is a perspective view showing, according to one variant, a part of the strapping strip and the support strip which, for the sake of clarity, is shown unmounted on the strapping strip.

FIG. 10 is a perspective view showing, according to another variant, a part of the strapping strip and the support strip.

### DETAILED DESCRIPTION

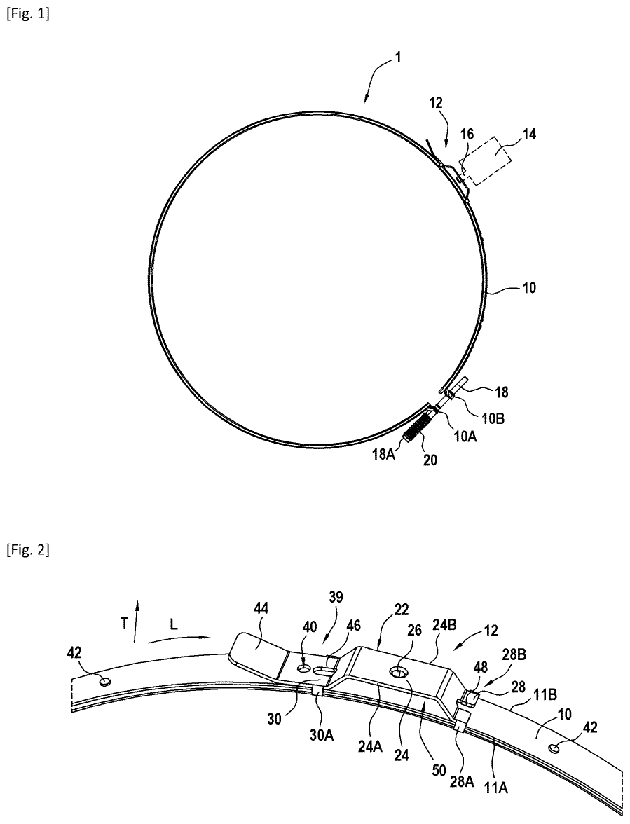

FIG. 1 shows a clamping collar 1 which comprises a strapping strip 10 and a mounting device 12 for mounting an accessory 14. The accessory is represented in a broken line and schematized by a block. In this case, it is fixed to the mounting device 12 by a threaded rod 16 screwed into the mounting device.

Within the meaning of the present disclosure, the longitudinal direction is the direction of the length of the strapping strip, considered when traveling along this strip from one of its ends 10A and 10B to the other of its ends. The width direction or transverse direction T is the direction perpendicular to this longitudinal direction measured in a straight line from one longitudinal edge to the other of the strapping strip.

The support strip 22 is elongated generally in the same way as the strapping strip 10, such that its longitudinal and transverse directions are the same as those of the strapping strip and are observed when the support strip is mounted on the strapping strip.

Within the meaning of the present disclosure, the inward direction is the direction directed towards the inside of the strapping strip when the strapping strip is disposed around an object, this inward direction goes from the strapping strip to the object it is strapping. Similarly, the inward direction regarding the support strip is observed when this strip is mounted on the strapping strip. The outward direction is the opposite direction.

Within the meaning of the present disclosure, the radial direction is the direction, assuming that the strapping strip would define a circle, oriented generally radially relative to this circle.

The clamping collar 1 is in this case a screw collar, the strapping strip 10 having two ends 10A and 10B cooperating with a clamping screw 18. In this case, the ends 10A and 10B form straightened wings, the screw 18 being screwed into the end 10B provided for this purpose with a nut, while being retained relative to the end 10B, in this case via a spring 20 which allows the strapping strip to make a clamping around the object it is strapping, while adapting to the variations in dimensions of this object. For example, the object in question may be a hydrogen tank whose contour may deform according to temperature variations or pressure variations in the tank. The spring 20 is in this case a helical spring disposed between the head 18A of the screw and the end 10A of the collar.

Of course, other collar clamping methods could be envisaged, for example a clamping by hooking of the ends of the collar onto each other, one of the ends having a hooking protrusion and the other having a hook that hooks onto this protrusion. The collar may as a variant have a closed contour, and may be able to be clamped by contraction of a deformable portion such as a radially protruding wing. Generally, any type of clamping can be envisaged, particularly a clamping by screwing, by crimping, by snap-fastening, by hooking or by plastic deformation.

Moreover, as indicated at the beginning of the present disclosure, the strapping strip may belong to a clamping collar, or to any type of strapping device. It is used to strap the object around which it is disposed, possibly but not necessarily by applying a clamping force to this object.

FIG. 2 shows the mounting device 12 in more detail. It is seen that it includes a support strip 22 itself comprising a fixing area 24 for the accessory 14. In this case, this area 24 comprises a fixing orifice 26 which has a tapping allowing the threaded rod 16 of the accessory to be screwed into this threaded orifice provided with a mating thread. Of course, this fixing method is only one exemplary embodiment. It could also be provided that the accessory is fixed in another manner, for example using several screws, using a hooking system, for example by having hooks that cooperate with the longitudinal edges 24A and 24B of the fixing area 24, by clipping, or by welding or clinching. A removable fixing will however be preferred, particularly a screwing as represented, or a hooking or a clipping.

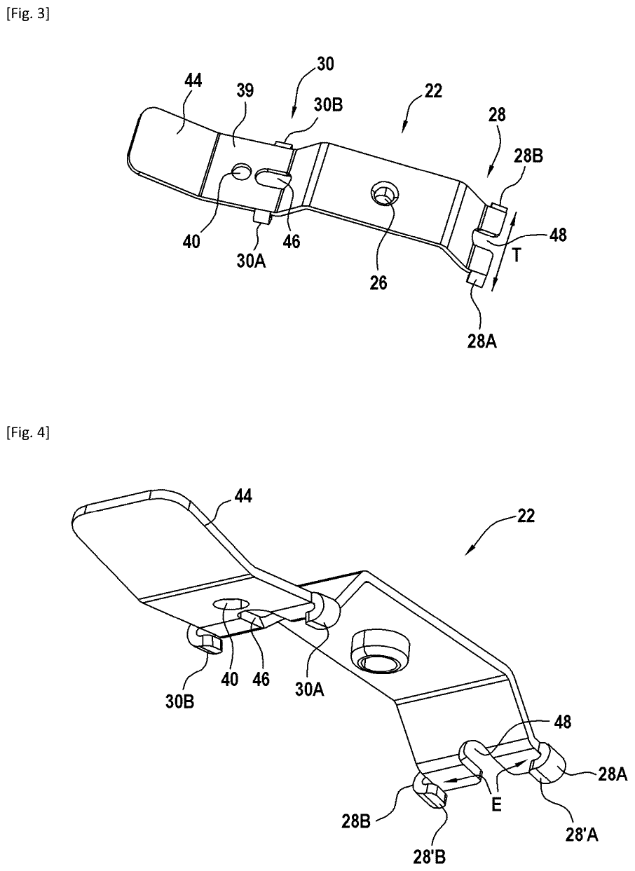

The mounting device 12 comprises a slide system for retaining the support strip 22 relative to the strapping strip 10. In this case, as better seen in FIGS. 3 and 4, the support strip has sliding lugs. In this case, two pairs of sliding lugs, respectively 28A, 28B and 30A, 30B are provided, each in a sliding area of the support strip, respectively 28 and 30. These pairs are similar. If the pair of sliding lugs 28A, 28B is considered for example, it is seen that it comprises two lugs carried by the sliding area 28 of the support strip 22, these lugs being spaced from each other in a width direction T and having ends 28′A, 28′B folded under the support strip 22 while arranging a space E between them and the inner face of the support strip. More specifically, the space E is arranged between the folded ends 28′A, 28′B and areas of the inner face of the support strip located facing these folded ends.

The two sliding lugs 28A and 28B are spaced from each other in the way of the width direction T. Thus, these two lugs are positioned on either side of the two longitudinal edges 11A and 11B of the strapping strip 10. The space E arranged between the folded ends 28′A and 28′B of the sliding lugs and the inner face of the support strip 22 is used to receive the edges 11A and 11B of the strapping strip.

The radial height of the space E is at least equal to the thickness of the edges 11A, 11B of the strapping strip, this thickness being measured radially. The radial height of the space E may be slightly greater than this thickness, so as to adapt to the curvature of the strapping strip.

In this case, as indicated, the slide system has two pairs of sliding lugs. Thus, when the support strip is mounted on the strapping strip, the sliding lugs of these two pairs engage the edges of the strapping strip in two longitudinally spaced areas. The two pairs of sliding lugs are disposed relative to each other by taking into account the curvature of the strapping strip to promote easy sliding. For example, the support strip 22 may follow the curvature of the strapping strip 10, which here means that the sliding areas 28 and 30 are disposed relative to each other by following this curvature. The pairs 28A, 28B on the one hand and 30A, 30B on the other hand are disposed on either side of the fixing area 24.

The mounting device 12 also comprises a locking system for blocking the sliding of the support strip relative to the strapping strip. In this case, this locking system comprises an aperture 40 formed in the support strip, aperture into which pins 42 formed in protrusion on the outer face of the strapping strip 10 may penetrate. Within the meaning of the present disclosure, the aperture 40 forms a first locking member, and the pins 42 form a second locking member. It is understood that when the support strip 22 is moved in sliding on the strapping strip 10, it may be blocked in the chosen position when one of the pins 42 is positioned in the aperture 40.

In general, according to one aspect of this disclosure, the first locking member may be formed in a blocking portion 39 of the support strip 22. In this case, this blocking portion 39 is an area of the support strip 22 which is naturally pressed against the outer face of the strapping strip 10. Thus, a pin 42 is naturally inserted into the aperture 40 when the latter comes in line with this pin. In this sense, the first locking member is permanently biased in a locking configuration in which the locking occurs naturally as soon as the first and second locking members reach the desired relative position. However, the blocking portion 39 may be moved elastically to allow the first locking member to escape the locking with the second locking member. In this case, the blocking area 39 may be slightly raised radially outwards to allow the unlocking or avoid the locking. This elastic displacement may take the form of an elastic deformation. According to one aspect of this disclosure, the support strip 22 comprises a locking tab 44 which is formed at one end of the support strip adjacent to the blocking portion 39 and which is raised outwards. The operator may thus act on this tab to raise the blocking portion 39 relative to the outer face of the strapping strip 10. According to one aspect, the blocking portion comprises an opening 46 located on the side opposite to the unlocking tab 44. This opening 46 forms a material lightening which may promote the elastic deformation of the blocking portion 39. In this case, the opening 46 is formed towards the junction between the blocking portion 39 and the fixing area 24 of the support strip 22. In this case, this opening is also formed between the two sliding lugs of one of the pairs of sliding lugs. This opening makes it possible to avoid excessive rigidity of the support strip 22 in the region of these sliding lugs, so as to prevent the sliding from being blocked in an undesirable manner and to give the two lugs of the pair an ability to move slightly relative to each other in order to avoid jamming of the sliding. This opening 46 also forms an area for receiving the pin 42 under the support strip 22 (on its internal side) in a region in which this strip is close to the outer face of the strapping strip 10, to avoid jamming of the sliding when, during the sliding, the pin passes through this area. Thus, in this case, the opening 46 is located in the sliding area 30.

It is seen that an opening or a slot 48 is also located in the first sliding area 28, between the sliding lugs 28A and 28B, also to allow the two lugs of this pair to move slightly relative to each other in order to avoid jamming of the sliding. Furthermore, like the opening 46, this opening or slot 48 also forms an area for receiving the pin 42, allowing it to pass under the support strip without jamming the sliding.

Referring in particular to FIGS. 1 and 2, it is seen that the fixing area 24 of the support strip 22 is formed in radial protrusion outwards relative to the sliding areas 28 and 30. The hollow space 50 is arranged between the inner face of the fixing area 24 and the outer face facing the strapping strip 10. In this case, this hollow space is located between the two sliding areas. Seen from one of the sides of the strapping strip, the fixing area has a general U shape, the two legs of which are turned inwards and in this case move slightly apart from each other while moving away from the base of the U, base in which the fixing member itself is arranged, this fixing member being here formed by the fixing orifice 26. It is also be seen that the openings 46 and 48 extend partly into these legs (at their ends opposite to the base of the U) to accommodate the height of the pin 42 so as to avoid jamming of the sliding of the support strip 22 on the strapping strip 10.

As can be seen in particular in FIGS. 2 to 4, this fixing orifice 26 has in this case the shape of a threaded skirt, the edges of this orifice being brought back radially so as to form a cylindrical sleeve which is threaded to be able to cooperate with the fixing screw of the accessory. In this case, this sleeve is directed inwards and extends into the aforementioned hollow space 50.

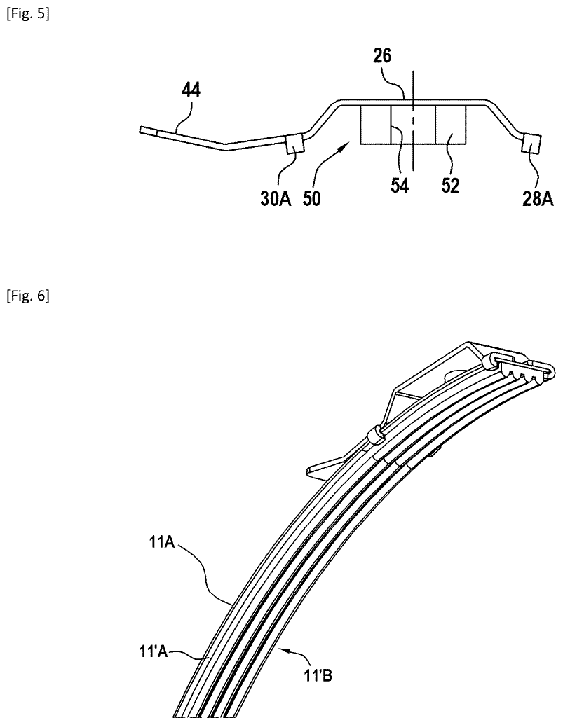

As shown in FIG. 5, it is possible however to arrange, in the hollow space 50, a nut 52 provided with a threaded drilling 54 in register with the fixing orifice 26. The nut may be welded or fixed in any other manner to the inner face or to the outer face of the fixing area 24. It may be preferred, as in the example represented, to place it on the side of the inner face of the fixing area 24, in the aforementioned space 50, in which case the fixing area 24 itself is maybe sandwiched between this nut and the accessory 14. In this case, the nut may not be previously fixed to the fixing area 24, or may be fixed therein while waiting to receive the accessory, without this fixing being particularly strong. The nut 52 may also be used as a spacer substantially filling the radial height of the space 50 to avoid excessive deformations of the fixing area 24.

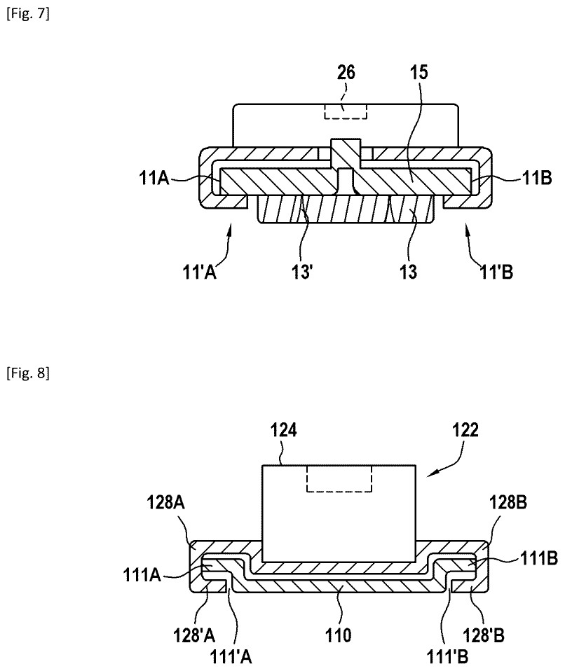

With reference to FIGS. 6 and 7, it is seen that the strapping strip 10 has a groove, respectively 11′A and 11′B on each of its longitudinal edges 11A, 11B. The folded ends of the sliding lugs 28A, 28B, 30A, 30B may therefore be inserted into these grooves. Thus, the sliding does not interfere with the interactions of the strapping strip with the object that is strapped or clamped by this strip.

In this case, the strapping strip comprises an inner strip 13 and an outer strip 15, the outer strip 15 projecting laterally relative to the inner strip 13, such that the grooves 11′A and 11′B are formed by these projections. For example, the outer strip may be a metal strip, for example made of stainless steel or austenitic steel, while the inner strip may be made of polymer material, added onto the inside of the outer strip, for example by bonding. In this case, the metal strip ensures the rigidity of the strapping, while the polymer strip, which may optionally be thicker and have longitudinal grooves 13′ which may give it certain flexibility, is the one that cooperates with the outer periphery of the strapped object. Thus, the contact between the strapping strip and the object it is strapping does not damage this object and may adapt to slight irregularities on the outer surface of this object.

In FIG. 8, the elements similar to those of FIGS. 1 to 7 are designated by the same references, increased by 100. FIG. 8 shows one variant of embodiment. in which the strapping strip 110 may be made in a single piece, but its longitudinal edges 111A and 111B may have raised rims so as to form, seen in cross section, steps under which the grooves 111′A and 111′B into which the folded ends 128′A and 128′B of the sliding lugs 128A and 128B may penetrate are formed.

On its outer face, the strapping strip 110 may thus have a central portion recessed relative to these raised rims. As shown in FIG. 8, the support strip 122 may, in the sliding areas in which the sliding lugs are formed, have a median portion radially set back inwards relative to the outer surfaces of the sliding lugs 128A and 128B, so as to be positioned in the recessed area of the outer face of the strapping strip. However, it could be provided that the support strip in this region has a straight cross-section, leaving a gap between it and the outer face of the recessed portion of the strapping strip. For the rest, the support strip 122 may be similar to the support strip 22 previously described, and the fixing portion 124 and the aperture 126 are in particular recognized.

In what has just been described with reference to FIGS. 1 to 8, the first locking member comprises an aperture 40 in which a pin 42 of the strapping strip engages. Of course, the aperture may be replaced by a boss whose interior forms a cup receiving the pin 42. Of course, the concept of pin covers any type of radial protrusion, for example a cut and straightened lug.

Conversely, it is also possible to provide that the pins 42 forming the second locking members are replaced by apertures or hollows formed on the outer face of the strapping strip, and in which the first locking member would engage, itself protruding on the inner face of the blocking portion 39 of the support strip. This first locking member may then be formed by one or more bosses protruding on the inner face of the blocking portion, forming a cup on the outer face of this blocking portion.

It may also be provided that the second locking members are formed by notches formed set back in the transverse direction on the edges of the strapping strip, and that the first locking member comprises one or more lugs formed on the edges of the blocking portion, protruding radially inwards, to engage in these indentations. In this case, the longitudinal length of the sliding lugs may be greater than the length measured in the same way of the notches of the longitudinal edges, so as not to penetrate into these notches during the sliding of the support strip on the strapping strip.

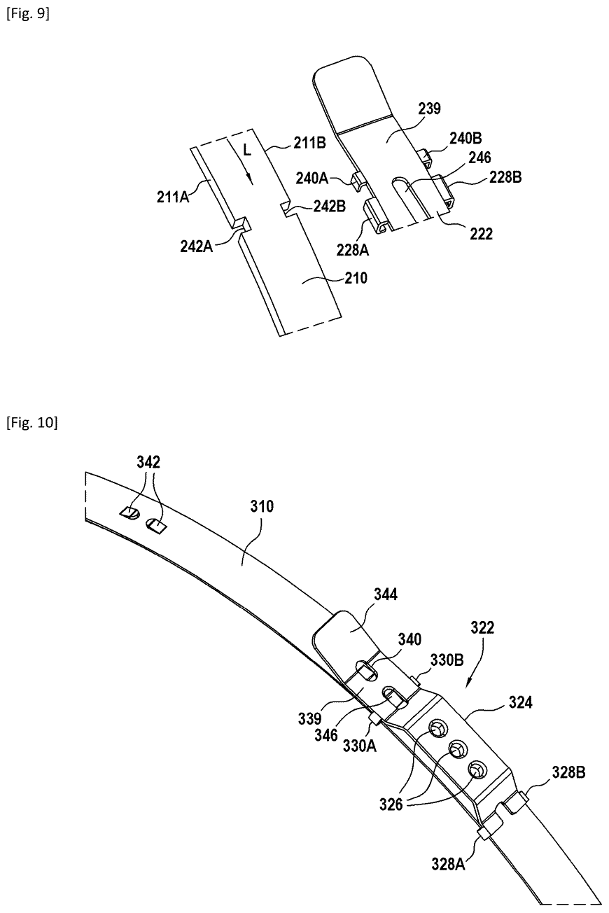

This is shown schematically in FIG. 9, in which the elements similar to those of FIGS. 1 to 7 are designated by the same references, increased by 200. This figure represents a portion of the strapping strip 210, on the edges 211A and 211B of which notches 242A and 242B which form the second locking members are made. FIG. 9 also shows a portion of the support strip 222, which has first locking members 240A and 240B formed by lugs protruding inwards so as to be able to be engaged in the notches 242A and 242B. The sliding lugs 228A and 228B protrude laterally further than the locking lugs 240A and 240B and are larger along the longitudinal direction L, so as not to penetrate into the notches 242A and 242B. For the rest, the strapping strip and the support strip may be similar to those of the other examples. In particular, the blocking portion 239 and the opening 246 are recognized.

In FIG. 10, the elements similar to those of FIGS. 1 to 7 are designated by the same references, increased by 300. The support strip 322 is thus recognized with its sliding lugs 328A, 328B, 330A and 330B. In this figure, another variant for the locking members is shown. In this case, the second locking members 342 formed on the strapping strip 310 comprise slashes, i.e. tabs whose free ends are partially cut in the strapping strip 310 and which are deformed radially outwards. For its part, the support strip 322 has a first aperture 340 and a second aperture 346 which together form the first locking member, the aperture 340 being between the aperture 346 and the tab 344. Two tabs 342 are shown engaged respectively in each of these apertures so as to block the strip 322 in its blocking position. The free ends of these tabs form ridges that allow the locking by blocking against the edges of the openings 340 and 346. The aperture 346 may be similar to the opening 46 of FIGS. 1 to 7 and, in addition to forming a part of the first locking member, also serve to prevent the support strip 322 from jamming when, during its sliding on the strapping strip 310, the locking area 339 in which it is located passes over the tabs 342. Thus, only the locking ridges of these tabs hold back the sliding, when they abut against the facing portions of the aperture 340 and 346.

Moreover, the variant of FIG. 10 is also distinguished from those of the previous figures by the fact that the fixing portion 324 has several fixing orifices 326, in this case three fixing orifices to ensure the fixing with the accessory. These orifices may each be similar to the orifice 26 previously described and, in particular, have threaded skirts or be in register with the screwing orifices of an insert nut.

1. A device for mounting an accessory on a strapping strip, the mounting device comprising a support strip comprising a fixing area for an accessory, a slide system for retaining the support strip relative to the strapping strip while allowing the support strip to slide along the strapping strip, and a locking system for blocking the sliding of the support strip along the strapping strip in a given position of the support strip relative to the strapping strip, a hollow space being arranged between an inner face of the fixing area and an outer face facing the strapping strip.

2. The device according to claim 1, wherein the slide system comprises at least one pair of sliding lugs, which comprises two sliding lugs carried by a sliding area of the support strip, the sliding lugs of each pair being spaced from each other in a width direction and having ends folded under the support strip by arranging a space therebetween and an inner face of the support strip.

3. The device according to claim 2, wherein the slide system comprises two pairs of sliding lugs respectively disposed on either side of the fixing area.

4. The device according to claim 1, wherein the fixing area is protruding radially outwards relative to the sliding area.

5. The device according to claim 4, wherein the fixing area is formed in a portion of the support strip that is deformed radially outwards.

6. The device according to claim 1, wherein the fixing area comprises at least one fixing orifice.

7. The device according to claim 4, wherein the fixing orifice is a threaded orifice of a skirt projecting from the support strip.

8. The device according to claim 1, wherein the support strip comprises a blocking portion which has a first locking member.

9. The device according to claim 8, wherein the first locking member is permanently biased in a locking configuration.

10. The device according to claim 9, wherein the blocking portion is configured to be elastically moved in order to unlock the first locking member so as to unblock the sliding.

11. The device according to claim 1, wherein the support strip comprises an unlocking tab, configured to be manipulated so as to unlock the locking system to unblock the sliding.

12. The device according to claim 10, wherein the unlocking tab is raised radially relative to the blocking portion.

13. An assembly comprising a strapping strip and a mounting device according to claim 1.

14. The assembly according to claim 13, comprising a clamping collar having the strapping strip.

15. The assembly according to claim 13, wherein the slide system comprises at least one pair of sliding lugs, which comprises two sliding lugs carried by a sliding area of the support strip, the sliding lugs of each pair being spaced from each other in a width direction and having ends folded under the support strip by arranging a space therebetween and an inner face of the support strip, and wherein the strapping strip has edges which are inserted into a space arranged between the folded ends of the sliding lugs and the inner face of the support strip.

16. The assembly according to claim 13, wherein the support strip comprises a blocking portion which has a first locking member and the strapping strip has a plurality of second locking members for cooperating with the first locking member, the second locking members being distributed over at least part of the length of the strapping strip.

17. The assembly according to claim 13, wherein the support strip comprises blocking portion which is permanently biased to be pressed against the outer face of the strapping strip for blocking the sliding of the support strip along the strapping strip.

18. The assembly according to claim 13, wherein the strapping strip has longitudinal edges, a groove on each one of the longitudinal edges.

19. The assembly according to claim 13, wherein the grooves are formed by raised rims on the longitudinal edges of the strapping strip.

20. The assembly according to claim 13, wherein the strapping strip comprises an inner strip and an outer strip, the outer strip projecting laterally relative to the inner strip so as to form grooves between longitudinal edges of the inner strip and longitudinal edges of the outer strip.
